(19) United States
(12) Patent Application Publication
(10) Pub. No.: US 2017/0198840 A1
(43) Pub. Date: Jul. 13, 2017

(54) A JOINT BOX OF FLEXIBLE LONG-LENGTH TUBES

(71) Applicant: Rivener Musavirovich Gabdullin, Moscow (RU)

(72) Inventor: Rivener Musavirovich Gabdullin, Moscow (RU)

(21) Appl. No.: 15/314,833

(22) PCT Filed: May 26, 2015
(86) PCT No.: PCT/RU2015/000332

§ 371 Date: Nov. 29, 2016

(30) Foreign Application Priority Data
Jun. 2, 2014 (RU) 2014122149

(51) Int. Cl. F16L 15/00; E21B 17/042

(52) U.S. Cl. CPC F16L 15/007; E21B 17/042

(57) ABSTRACT

This invention relates to releasable couplings for long lengths of tube and rod, in particular for coupling long-length flexible tubes, long-length flexible rod, and also for boring and casing pipes, production tubing and collapsible pipelines. The present releasable coupling for flexible long-length tubes comprises threaded nipples, mounted on the ends of tubes to be connected, and a threaded sleeve, wherein the thread on the two nipples has a different pitch and the threaded sleeve has two threaded portions for mutual coupling thereof, and wherein the nipple with the larger pitch is provided with a runout in the form of a cylindrical groove or non-threaded portion, the length of which together with the distance of approach of the tubes is greater than the length of the larger-pitch thread on the sleeve. The result is an increase in the reliability, durability and tightness of the coupling.

### FIELD OF THE INVENTION

The present invention refers to detachable connectors for long tubes and sucker rods. To be more exact it can be used for connection of long flexible tubes (coiled tubings), sucker rods, collapsible (demountable) pipelines, and also of drilling, casing and tubing strings.

### PRIOR ART

The experience of using long flexible tubes to carry out operations in the well shows that as the well deepens it becomes reasonable to use long compound flexible pipes. Moreover, the invention must provide for the case when there is a need to remove a damaged section from the string of flexible tubes and pipelines with further mechanical connection of pipe ends. In any case, it is required to use a detachable connector able to ensure a reliable, strong and leakproof joint for the two ends of long tubes excluding their turning relative to each other.

Known is a detachable joint of long flexible tubes consisting of screwed nipples rigidly connected with the ends of tubes to be joined, and a threaded sleeve. In assembling tubes the distance between the coupled nipple faces is multiple of thread pitch. To guarantee the specified distance between the coupled nipple faces in assembling the joint includes a retainer clip with lips located in nipple grooves. Between the sleeve and nipple faces there is a compression spring. The sleeve and nipple threads are single or multiple. (RF U.S. Pat. No. 2,231,616 dated 15 Dec. 2002).

The disadvantage is that the problems with matching of sleeve and nipple thread starts caused by rigidly located relative to each other pipe ends make it difficult to assemble the detachable joint with the auxiliary retainer clip. Moreover there is no tightness in threads and therefore no joint tightness.

Known is a detachable joint of long flexible pipes consisting of a hollow body with its channel connected upper and lower ends, a gripping and sealing system of coiled tubing located at the upper end of the hollow body, an element which is movable and sealed relative to the hollow body and located at the lower end of the hollow body with a lip below of which there is a stop ring for it on the hollow body. At the lower end of the hollow body there are pockets and the shoulders of the movable part have lugs. When the movable element is in its upper position relative to the hollow body there are perimeter holes with bolts in the latter which in driving fall into the annular groove in the movable part and fix it relative to the hollow body. Lugs on the shoulders of the movable part are in the hollow body pockets thus preventing their turning relative to each other. (U.S. Pat. No. 6,439,618 dated 4 May 1998).

The disadvantage is that its manufacturing process is complicated and costly, bolting is unreliable, elements are numerous. Availability of a great number of end and radial plays, as well as the absence of tightness diminishes reliability of the entire detachable joint.

Known is a detachable joint of long coiled tubes taken as a prototype consisting of two connectable and lockable elements each of which is threaded on the screwed end connections of long flexible tubes or of a long flexible tube and downhole equipment. One part of the joint has a cone-shaped slotted boss. The slots converge towards the cone point. The second part of the joint has a cone-shaped pocket with grooves for slots narrowing towards the cone point. For each pair of the cone-shaped connections there are coupled cylindrical parts on the cone points. To lock the stop sleeve there are two semi-rings with annular grooves (U.S. Pat. No. 6,460,900 dated 2 Aug. 1999).

The disadvantage is that the manufacturing process of narrowing slots and narrowing grooves on the coupled cones is complicated and costly. Constant presence of axial and radial plays between the stop sleeve and the upper part of the joint, as well as the absence of thread tightness between the upper and lower parts considerably effect tightness of the joint.

The invention under consideration is to remove the above mentioned drawbacks.

The technical effect achieved is that the invention makes possible to assure a tight, strong and more reliable connection enabling to fix the detachable joint thus preventing its turning during trips and when carrying out operations in the well.

### SUMMARY OF THE INVENTION

The above task has been solved and the technical effect achieved due to the joint box of flexible long-length tubes, consisting of screwed nipples fixed at the ends of tubes to be connected, with lugs at the end of one nipple and mate grooves at the end of the other one, and a threaded sleeve, wherein both nipples are threaded with different pitches, and a threaded sleeve is made with two threaded sections, the thread pitch on each of them matching the thread pitch of the mate nipple for their interconnection, and threads of all connected elements of the joint are made with single thread hand, along with this there is a runout made as a cylindrical groove on the nipple with longer thread pitch or a threadless nipple section the length of which together with the distance of approach of tubes to be connected up to the leak-proof joint is greater than the thread length with longer sleeve pitch.

The sleeve is screwed on the nipple with shorter pitch.

The sleeve and nipple thread is made single or multiple.

Lugs at the end of one nipple and mate grooves at the end of the other one are arranged in axial direction of the detachable joint.

When connecting long flexible tubes inside or outside of a string one can locate (single-tube as sections) electrical cables, wires and/or hydraulic channels arranged along the tube wall and attached to it.

In tubes there is an additional wall dividing the tube interior content into two channels which are combined when connecting tubes, with separated channels in the assembled string being formed.

When connecting two nipple ends an effective face seal of “metal-metal” type is formed or a leak-proof elastic seal is installed in their face contact.

### BRIEF DESCRIPTION OF THE DRAWINGS

The invention offered is illustrated through drawings.

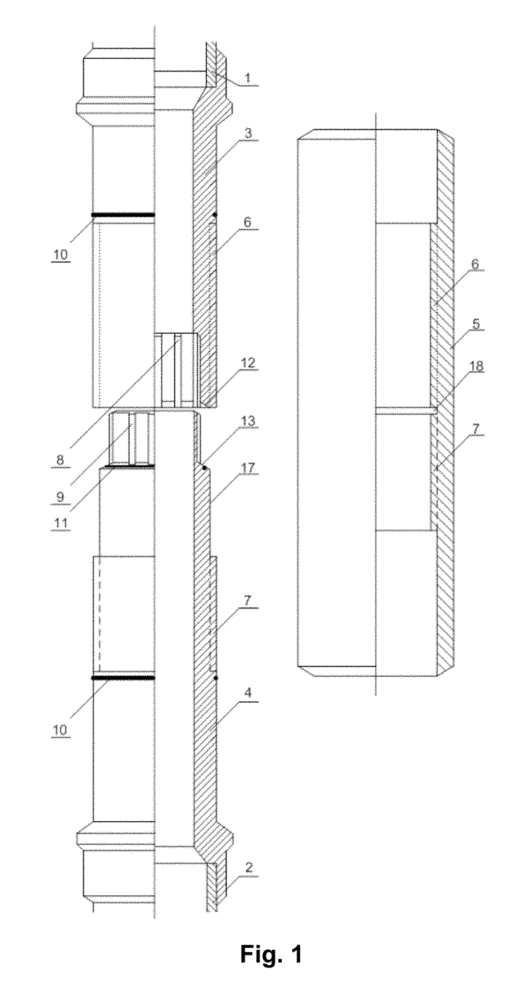

The FIG. 1 gives the detached view of the joint tubes and elements.

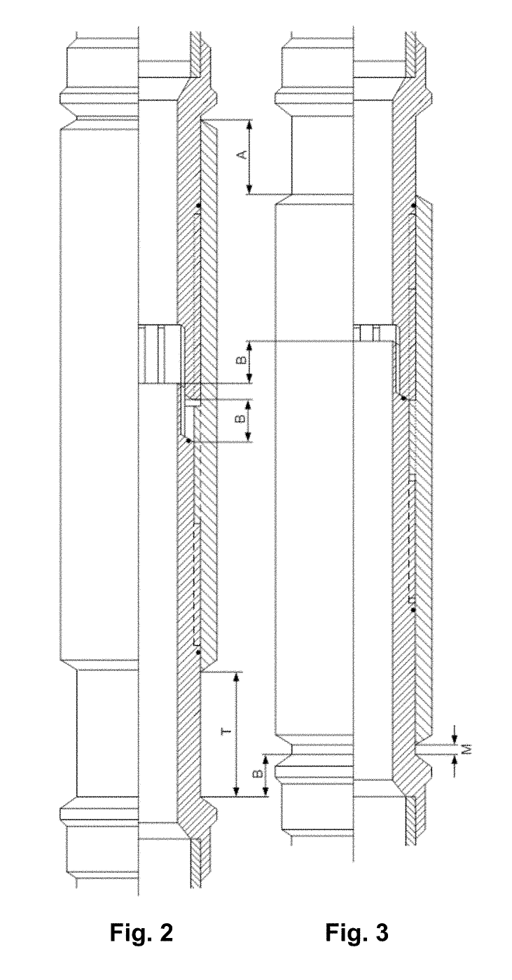

The FIG. 2 shows the joint prior to its assembling.

The FIG. 3 shows the joint after its assembling is completed.

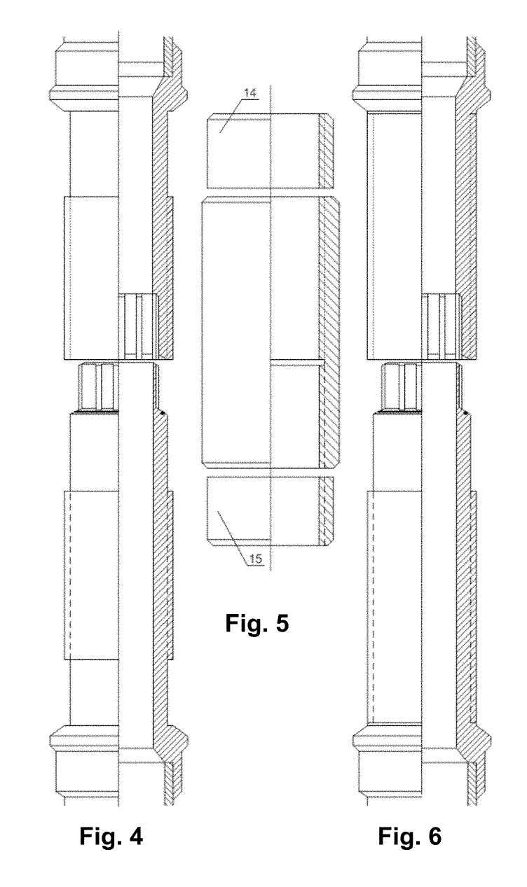

The FIG. 4 illustrates the optional design of nipples for the detachable joint with two counter-sleeves.

The FIG. 5 shows the sleeve with two counter-couplings.

The FIG. 6 gives one more option for the joint nipples with two counter-couplings.

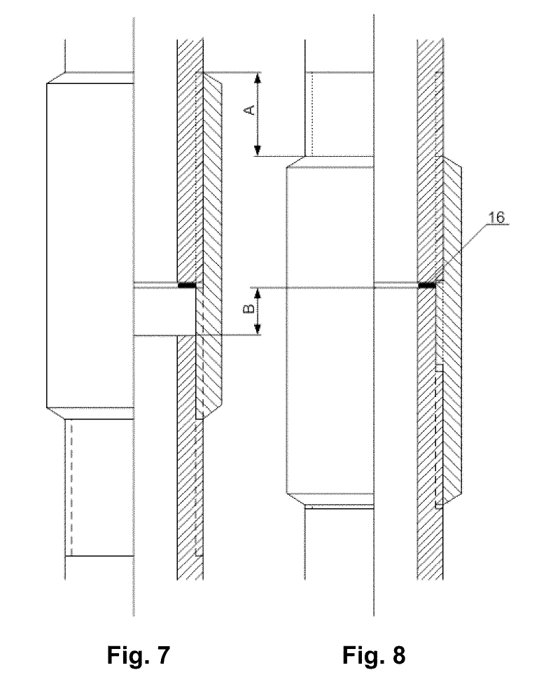

The FIG. 7 shows the simplified detachable joint prior to its assembling.

The FIG. 8 shows the simplified detachable joint after its assembling.

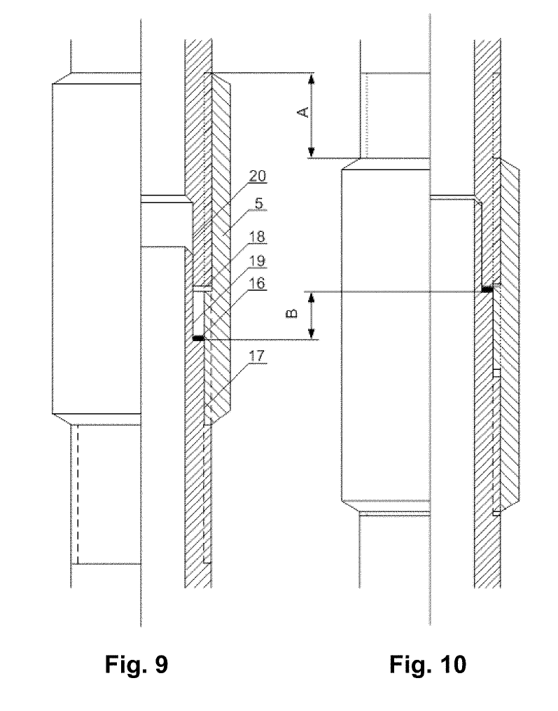

The FIG. 9 shows the simplified detachable joint with the guide bush prior to its assembling.

The FIG. 10 gives the post-assembling view of the simplified detachable joint with the guide bush.

### DESCRIPTION OF THE BEST EMBODIMENT

The detachable connector for a long-length flexible tubes comprises long flexible tubes 1 and 2 to be connected, at the ends of which the threaded nipples 3 and 4 are fixed, say by means of welding, connected using the threaded coupling 5 (FIG. 1). Nipple 3 has thread 6, while nipple 4—thread 7, the pitch of thread 6 being less than the one of thread 7. Nipple 4 has runout 17 as a cylindrical groove, its length together with the approach distance of tubes to be connected being greater than the thread length with the sleeve coarse pitch. The lengths of threads 6 and 7, as well as the length of runout 17 are design variables. There are circumferential matching grooves 8 on the faces of nipples 3 and 4 and lips 9, say as slots, enabling axial movement of both nipples relative to each other. To ensure tightness of the detachable joint there are sealings 10 and 11 fixed on nipples 3 and 4. For centering of the detachable joint the contact point of butts 12 and 13 of both nipples is made cone and interfacing. To fix the threaded connections of the coupling 5 both of its ends can have the counter-coupling 14 with thread 6 of fine pitch and counter- coupling 15 with thread 7 of coarse pitch (FIG. 4, 5, 6). Coupling and nipple threads are made of the same thread hand (right or left) and can be either single or multiple. To separate threads 6 and 7 and for their ease threading the coupling 5 can have the technological cavity 18. For the simplified detachable joint (FIGS. 7 and 8) one can use the face seal 16. To simplify centering of the ends to be connected and increase breaking strength of the joint one of the nipples can have the guide bush 19 for which the end of the other nipple can have the mate cavity 20 (FIGS. 9 and 10).

Connection of tubes is performed as follows:

Threaded nipples 3 and 4 are inserted into the end parts of tubes 1 and 2 and fixed there by welding, glue or mechanically (press fit, connections of GRUB SCREW/DIMPLE, SUR-GRIP or others) (FIG. 1). Next, the entire thread 6 is used to screw coupling 5 into nipple 3. The connecting tubes 1 and 2 with nipples 3 and 4 at their ends and with nipple 3 screwed threaded coupling 5 are moved towards each other (FIG. 2). Nipple 4 enters coupling 5 and with further movement the lugs 9 of nipple 4 enters grooves 8 of nipple 3 for design variable and the start of thread 7 on the coupling 5 contacts the start of thread 7 on the nipple 4.

In turning of coupling 5 there occurs nipple 4 screwing-on along thread 7 and simultaneous coupling 5 screwing-off from thread 6 of nipple 3, but since the pitch of thread 7 is greater than that of thread 6 both nipples start approaching each other (FIG. 3). To determine the shift magnitude of every segment of the threaded joint relative to each other the following formulas are given:
B=C−A, while C=T−M, where:
B—Factor of approach (the distance between the face 12 of nipple 3 and face 13 of nipple 4 when start of thread 7 on coupling 5 contacts start of thread 7 of nipple 4),
A—Factor of screwing-off (screwing off magnitude of coupling 5 from nipple 3 with shorter thread pitch 6),
C—Factor of screwing-in (screwing-in magnitude of coupling 5 on nipple 4 with longer thread pitch 7),
T—the distance between the datum point of nipple 4 and the datum point at the end of coupling 5 with longer thread pitch 7 before the start of screwing-in of coupling 5,
M—the distance between the datum point of nipple 4 and the datum point at the end of coupling 5 with longer thread pitch 7 when screwing-in of coupling 5 is close to the end.

The number of turns n of threaded coupling 5 till complete connection of tube ends is calculated to the formula: n=B:b, where: b—the difference in pitch of long and short threads.

In contacting of cone and interfacial butts 12 & 13 of nipples 3&4 and complete connecting of tube ends, by additional rotating force applied at coupling 5 the tightness of both threads is increased thus making threaded joints extra strong and sealed. For additional fixation of coupling 5 one can use two tube wrenches, with the second wrench being able to grab either nipple 3 or nipple 4. To prevent coupling 5 from screwing-off when performing advanced operations in the well the thread of coupling 5 can be fixed either with counter-sleeves 14&15 (FIGS. 4,5 & 6). or just one of them. Assembly—disassembly of the joint can be performed manually. For stationary piping systems, such as gas-and water supply, as well as for field piping one can use the simplified version (FIGS. 7&8)—when the ends of pipes to be connected are threaded with different pitches or, as another version, with similar pitches but in assembling the pipes with different pitches alternate.

In both cases threaded sleeves with different thread pitches at their ends are used. The faces of tubes to be connected can have seals of “metal-metal” type or flexible seals. Since there are no slotted areas at nipple ends in assembling it is necessary to keep the tube to be connected motionless, say using a tube wrench. To prevent tubing itself from turning when screwing the sleeve, especially at the very start of its assembling, it is possible to hold tubing motionless using the second tubing wrench. Any leakage found in a threaded joint or pipe body can be easily removed by mechanical replacement of the leaking section. In the same way one can remove ruptured sections as well. Installation of any additional connections, branches, gate valves, recording units etc. can be performed in a quick and safe way by replacement of an appropriate threaded piping section. For every thread it is possible to use a sealing grease.

The detachable joint of long flexible tubes can be:
a) with external diameter equal to external tube diameter,
b) with internal diameter equal to internal tube diameter,
c) with external and internal diameters different from external and internal tube diameters.

The threaded joint of a long flexible tube can be used for normal drilling, casing and tubing strings when it is necessary to connect tubes excluding their turning relative to each other. In this case inside or outside of a string one can locate (single-pipe as sections) electrical cables, wires and/or hydraulic channels arranged along the tube wall and attached to it. But there is an alternative: one can use tubes with an additional wall dividing its interior content into two channels which are combined after the tubes connection and which form separated channels in the assembled string to run electrical and geophysical cables, instrumentation wires, capillary tubes, all metal or hollow rods, coiled tubing, etc. When using torqueing counter-sleeves to fix a threaded joint of long-length flexible tubes, drilling, casing and tubing strings, the latter having the opportunity to turn around the entire string both left and right. Instead of expensive cone-shaped threads cheap cylindrical threads are used. The detachable joint offered here can be used to connect several strings, such as multichannel coiled tubing. The simplified detachable joint (FIGS. 7 & 9) can be used in easy demountable pipelines for transportation of various gases and fluids. Taking into account that when joining two pipe ends their faces contact, one can use more effective face seal of “metal-metal” type or known leak-proof seals for connection of drilling, casing and tubing strings.

### INDUSTRIAL APPLICABILITY

The present invention can be used in oil, gas and other fields of industry.

1. A joint box of flexible long-length tubes, consisting of comprising:
a first and second threaded nipples fixed at an end of a first tube and an end of a second tube, respectively,
lugs at an end of the first nipple and mate grooves at an end of the second nipple,
a threaded coupling,
wherein a threaded sleeve is made with two threaded sections, a thread pitch on each section matching different thread pitches of the first and second nipple for their interconnection, and
wherein threads of all connected elements of the joint are made with a single thread hand, and
a runout made as a cylindrical cavity on the first nipple having a longer thread pitch than the second nipple or a threadless nipple section, the length of said runout together with the distance of approach of the tubes to be connected being greater than the thread length of the longer thread pitch of the first nipple.

2. The joint box of claim 1 wherein the sleeve is screwed on the nipple with shorter pitch.

3. The joint box of claim 1 wherein the sleeve and nipple thread is made single or multiple.

4. The joint box of claim 1 wherein the lugs at the end of the first nipple and the mate grooves at the end of the second nipple are arranged in an axial direction of the detachable joint.

5. The joint box of claim 1 wherein electrical cables, wires and/or hydraulic channels are arranged along a tube wall and attached to the tube wall inside or outside of a string, when flexible long-length tubes are connected.

6. The joint box of claim 1 wherein inside the tubes there is an additional wall dividing the tube interior into two channels which are combined when connecting tubes, with separated channels in the assembled string being formed.

7. The joint box of claim 1 wherein when connecting two nipple ends an effective face seal of “metal-metal” type is formed or a leak-proof elastic seal is installed in a face contact.
